(19) United States
(12) Patent Application Publication
(10) Pub. No.: US 2013/0051321 A1
(43) Pub. Date: Feb. 28, 2013

(54) MULTIPLE DESCRIPTION CODING (MDC) FOR CHANNEL STATE INFORMATION REFERENCE SIGNALS (CSI-RS)

(71) Applicants: Alan Barbieri, San Diego, CA (US); Tingfang Ji, San Diego, CA (US); Peter Gaal, San Diego, CA (US)

(72) Inventors: Alan Barbieri, San Diego, CA (US); Tingfang Ji, San Diego, CA (US); Peter Gaal, San Diego, CA (US)

(73) Assignee: QUALCOMM INCORPORATED, San Diego, CA (US)

(21) Appl. No.: 13/589,990

(22) Filed: Aug. 20, 2012

Related U.S. Application Data
(60) Provisional application No. 61/526,994, filed on Aug. 24, 2011.

(51) Int. Cl. H04W 4/00

(52) U.S. Cl. 370/328

(57) ABSTRACT

Aspects of the present disclosure include a wireless system to reduce quantization error due to codebook-based PMI reporting by precoding channel state information reference signals (CSI-RSs) via a base station. The eNodeB varies the properties for a CSI-RS transmission in a known pattern and receives varying reports from the UE. The eNodeB can reconstruct the PMI with improved accuracy by combining multiple consecutive reports.

### CROSS-REFERENCE TO RELATED APPLICATION

This application claims the benefit under 35 U.S.C. §119(e) to U.S. Provisional Patent Application No. 61/526,994 entitled “METHOD AND APPARATUS FOR APPLYING MULTIPLE DESCRIPTION CODING (MDC) TO CHANNEL STATE INFORMATION REFERENCE SIGNALS (CSI-RSs),” filed on Aug. 24, 2011, the disclosure of which is expressly incorporated by reference herein in its entirety.

### BACKGROUND

1. Field

Aspects of the present disclosure relate generally to wireless communication systems, and more particularly to reducing quantization error due to codebook-based PMI reporting by precoding channel state information reference signals (CSI-RSs) via a base station.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

Aspects of the present disclosure are directed to reducing quantization error due to codebook-based PMI reporting. Multiple description coding (MDC)-type results are achieved by precoding CSI-RS transmissions with varying parameters (e.g., varying beam directions), using only once codebook. The eNodeB varies the properties for a CSI-RS transmission in a known pattern and receives varying reports from the UE. The eNodeB can reconstruct the PMI with improved accuracy by combining multiple consecutive reports.

In one aspect, a method of wireless communication is disclosed. The method includes transmitting, from an eNodeB, a first channel state information reference signal (CSI-RS) to a UE(s) using a first beam. A second CSI-RS is transmitted to a UE(s) using a second beam. The second beam differs from the first beam. The eNodeB receives precoding matrix indicators (PMI) from at least one UE for the transmitted CSI-RSs.

Another aspect discloses an apparatus including means for transmitting a first channel state information reference signal (CSI-RS) to a UE(s) using a first beam. A means for transmitting a second CSI-RS to a UE(s) using a second beam is also included. The second beam differs from the first beam. Also included, is a means for receiving precoding matrix indicators (PMIs) from at least one UE for the transmitted CSI-RSs.

In another aspect, a computer program product for wireless communications in a wireless network having a non-transitory computer-readable medium is disclosed. The computer readable medium has non-transitory program code recorded thereon which, when executed by the processor(s), causes the processor(s) to perform operations of transmitting a first channel state information reference signal (CSI-RS) to a UE(s) using a first beam. The program code also causes the processor(s) to transmit a second CSI-RS to a UE(s) using a second beam, where the second beam differs from the first beam. The program code also causes the processor(s) to receive precoding matrix indicators (PMIs) from at least one UE for the transmitted CSI-RSs.

Another aspect discloses wireless communication having a memory and at least one processor coupled to the memory. The processor(s) is configured to transmit a first channel state information reference signal (CSI-RS) to a UE(s) using a first beam. The processor(s) is also configured to transmit a second CSI-RS to a UE(s) using a second beam, where the second beam differs from the first beam. The processor(s) is also configured to receive precoding matrix indicators (PMIs) from at least one UE for the transmitted CSI-RSs.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of an access network.

FIG. 3 is a diagram illustrating an example of a downlink frame structure in LTE.

FIG. 4 is a diagram illustrating an example of an uplink frame structure in LTE.

FIG. 5 is a diagram illustrating an example of a radio protocol architecture for the user and control plane.

FIG. 6 is a diagram illustrating an example of an evolved Node B and user equipment in an access network.

FIG. 7 is a diagram conceptually illustrating coordinated codebook cycling.

FIG. 8 is a block diagram illustrating reference signal configurations within a resource block.

FIG. 9 is a diagram conceptually illustrating coordinated beam cycling with a single codebook, according to an aspect of the present disclosure.

FIG. 10 is a block diagram illustrating a method for varying channel state information reference signals.

FIG. 11 is a conceptual data flow diagram illustrating the data flow between different modules/means/components in an exemplary apparatus.

FIG. 12 is a block diagram illustrating an example of a hardware implementation according to an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Aspects of the telecommunication systems are presented with reference to various apparatus and methods. These apparatus and methods are described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

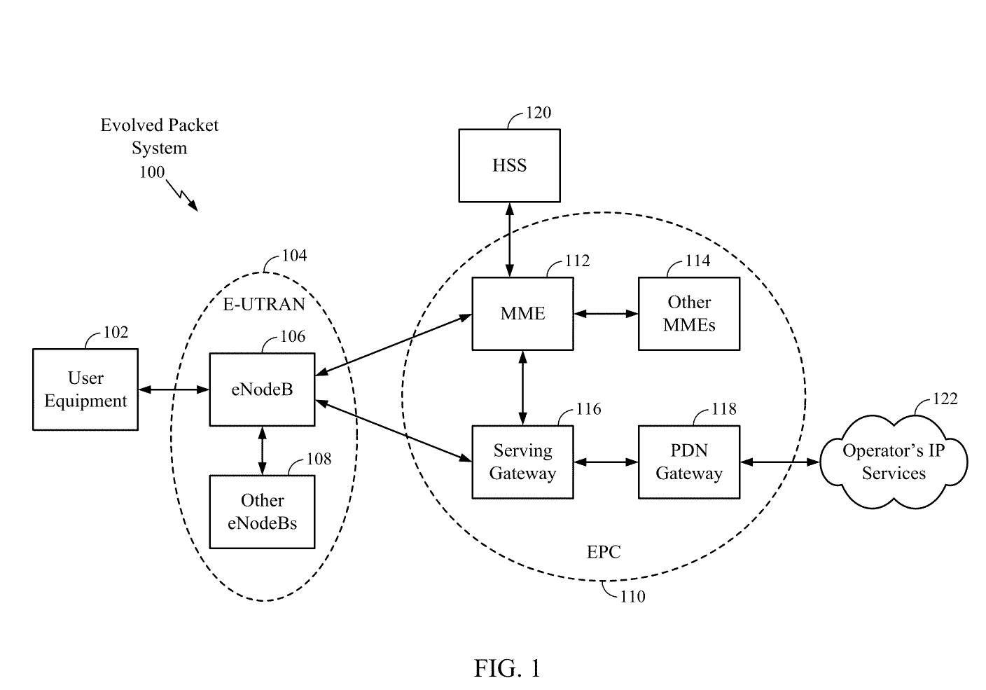

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an S1 interface. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

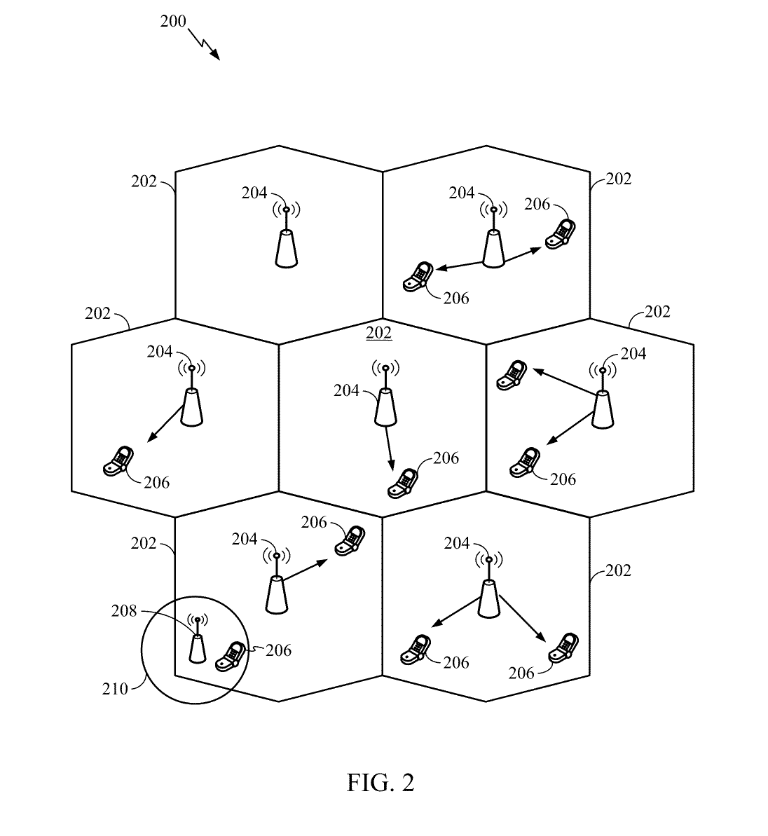

FIG. 2 is a diagram illustrating an example of an access network 200 in an LTE network architecture. In this example, the access network 200 is divided into a number of cellular regions (cells) 202. One or more lower power class eNodeBs 208 may have cellular regions 210 that overlap with one or more of the cells 202. The lower power class eNodeB 208 may be a remote radio head (RRH), a femto cell (e.g., home eNodeB (HeNodeB)), pico cell, or micro cell. The macro eNodeBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNodeBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the downlink and SC-FDMA is used on the uplink to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or U1tra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), U1tra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNodeBs 204 may have multiple antennas supporting MIMO technology. The use of MIMO technology enables the eNodeBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the downlink. The spatially precoded data streams arrive at the UE(s) 206 with different spatial signatures, which enables each of the UE(s) 206 to recover the one or more data streams destined for that UE 206. On the uplink, each UE 206 transmits a spatially precoded data stream, which enables the eNodeB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the downlink. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The uplink may use SC-FDMA in the form of a DFT-spread OFDM signal to compensate for high peak-to-average power ratio (PAPR).

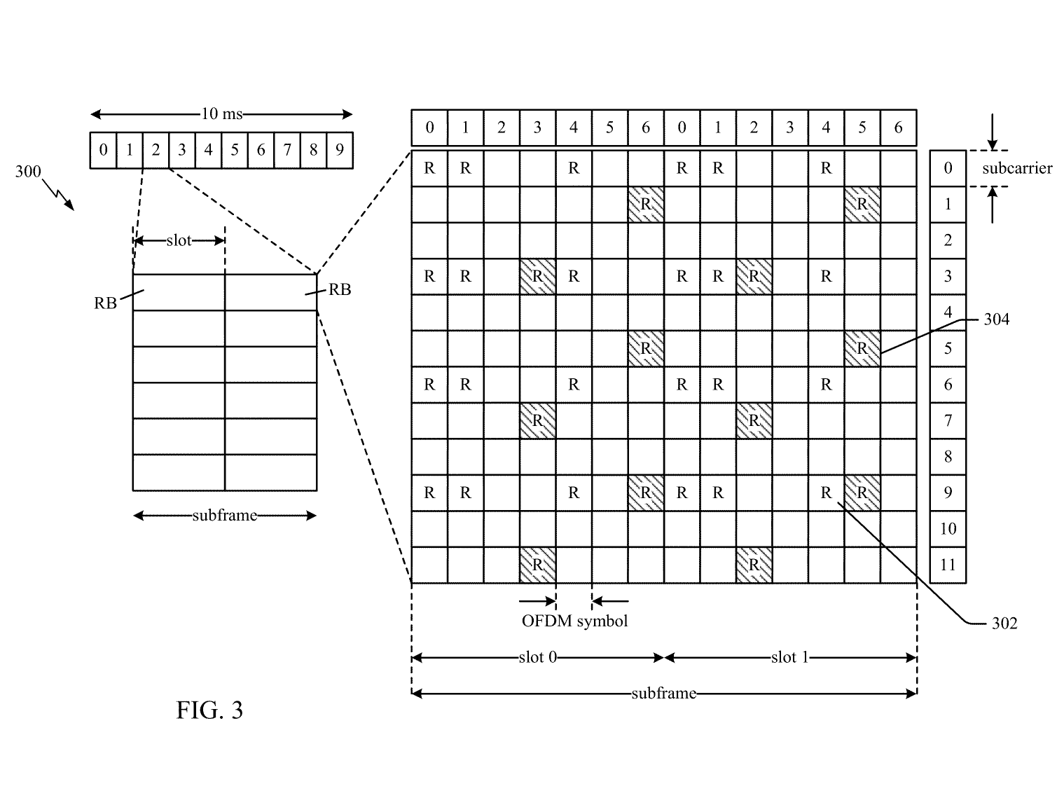

FIG. 3 is a diagram 300 illustrating an example of a downlink frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include downlink reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

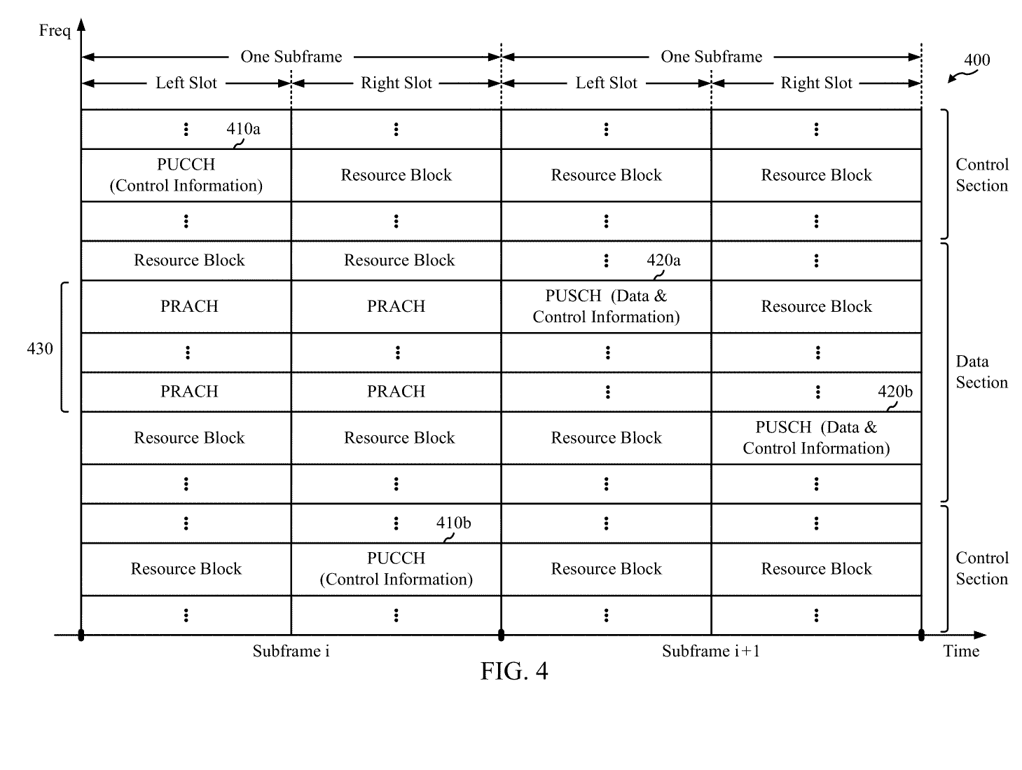

FIG. 4 is a diagram 400 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 410a, 410b in the control section to transmit control information to an eNodeB. The UE may also be assigned resource blocks 420a, 420b in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency.

A set of resource blocks may be used to perform initial system access and achieve uplink synchronization in a physical random access channel (PRACH) 430. The PRACH 430 carries a random sequence and cannot carry any uplink data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

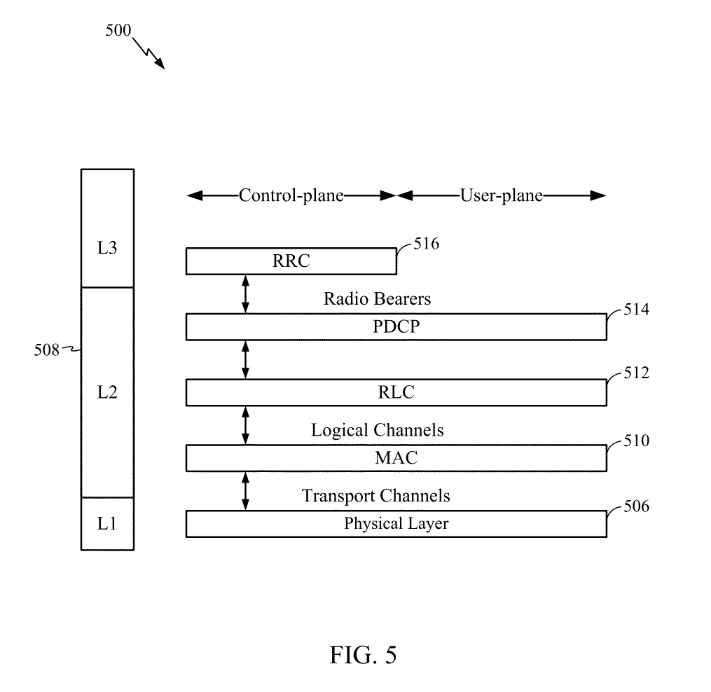

FIG. 5 is a diagram 500 illustrating an example of a radio protocol architecture for the user and control planes in LTE. The radio protocol architecture for the UE and the eNodeB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNodeB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNodeB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNodeBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNodeB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNodeB and the UE.

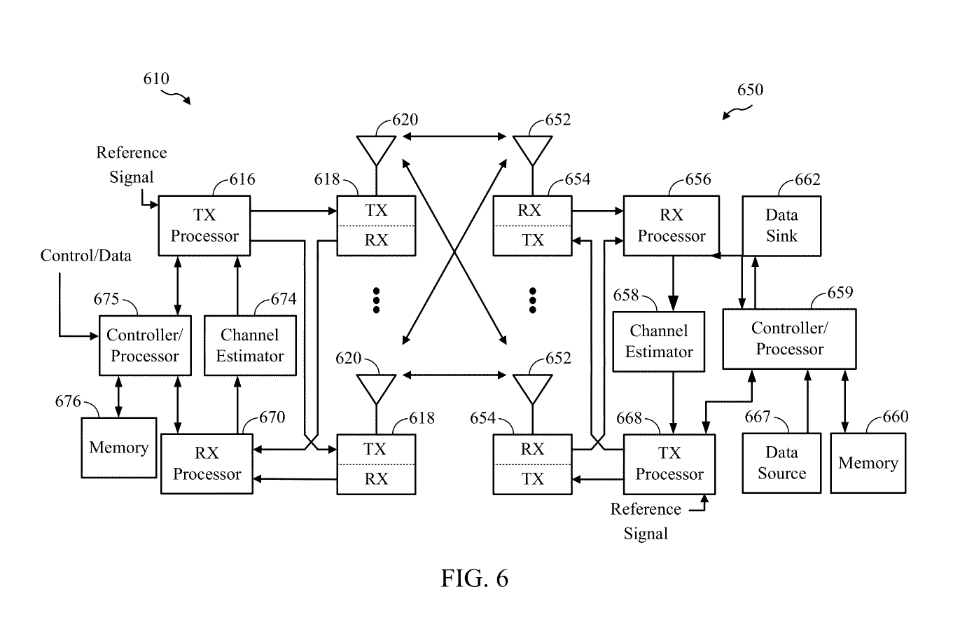

FIG. 6 is a block diagram of an eNodeB 610 in communication with a UE 650 in an access network. In the downlink, upper layer packets from the core network are provided to a controller/processor 675. The controller/processor 675 implements the functionality of the L2 layer. In the downlink, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNodeB 610. These soft decisions may be based on channel estimates computed by the channel estimator 658. The soft decisions are then decoded and deinterleaved to recover the data and control signals that were originally transmitted by the eNodeB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the uplink, the control/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the uplink, a data source 667 is used to provide upper layer packets to the controller/processor 659. The data source 667 represents all protocol layers above the L2 layer. Similar to the functionality described in connection with the downlink transmission by the eNodeB 610, the controller/processor 659 implements the L2 layer for the user plane and the control plane by providing header compression, ciphering, packet segmentation and reordering, and multiplexing between logical and transport channels based on radio resource allocations by the eNodeB 610. The controller/processor 659 is also responsible for HARQ operations, retransmission of lost packets, and signaling to the eNodeB 610.

Channel estimates derived by a channel estimator 658 from a reference signal or feedback transmitted by the eNodeB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The uplink transmission is processed at the eNodeB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the uplink, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

Multiple description coding can improve channel state information (CSI) reporting by reducing the quantization error due to codebook-based precoding matrix indicator (PMI) reporting. The general idea of multiple description coding consists of using multiple code descriptions to improve the accuracy of the source representation at the receiver.

One aspect of this may be implemented, for example, by using different codebooks with the same statistical properties at different time instances. In particular, the UE cycles through various different codebooks when reporting PMI. The codebooks may have similar statistical properties, for example, antenna configurations, channel conditions, geography spatial/diversity, etc. Essentially, the codebooks may only vary the properties of one statistical property when cycling through codebooks.

For example, the codebooks may be optimized based on antenna correlation. The quantization granularity is similar between codebooks for a given property. That is, each codebook, used alone, will achieve the same performance or quantization as any other optimal codebook.

However, by using different codebooks, in particular, if antennas are correlated according to some (known) statistical rule, the use of multiple codebooks can be coordinated so that a refined quantization can be determined for correlated channel vectors (known as vector quantization). That is, by combining reports generated using codebooks with similar statistical properties, where each codebook is optimized using similar assumptions regarding the antenna correlation may allow for a refined channel determination.

The UE cycles between codebooks while assuming the channel is slowly varying and that consecutive estimates may be highly correlated. The eNodeB is aware of the employed codebooks, and may decide to combine two or more consecutive reports and thereby obtain a more refined representation (e.g., one with reduced quantization noise).

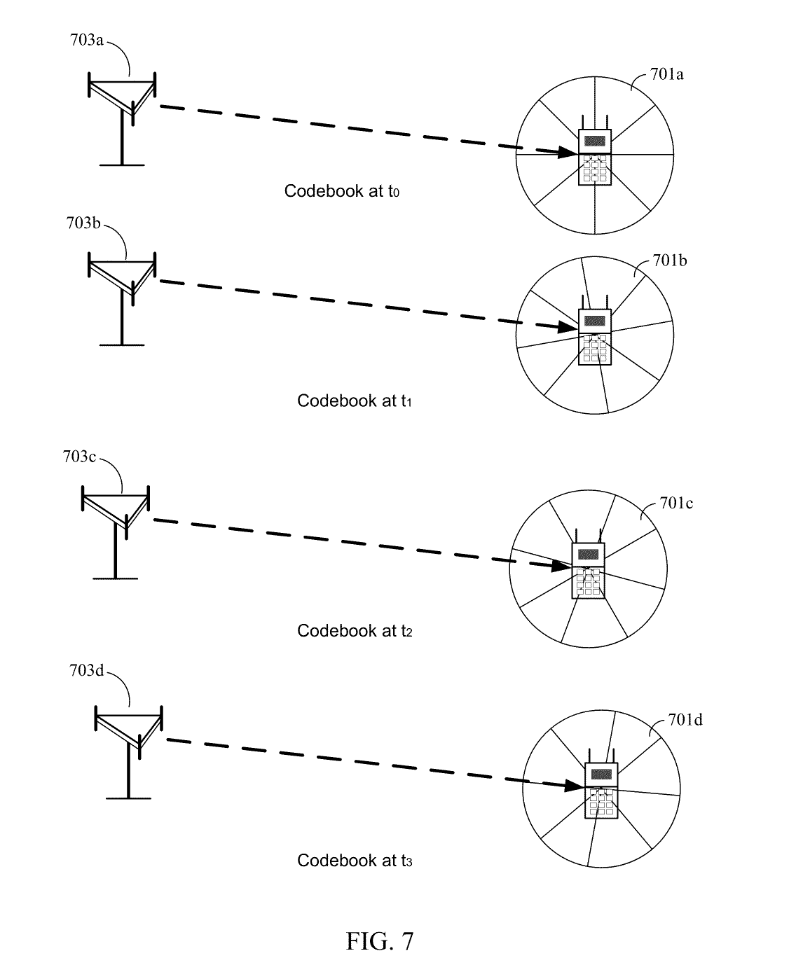

FIG. 7 shows an example system using multiple codebooks. In particular, each pinwheel 701a-701d represents a slightly different codebook, where the impact of the beam on the different codebooks provides a slightly different quantized PMI value (e.g., the beam hits a different slice of the pie or different part of a slice). Based on the known codebook and corresponding PMI, the eNodeB 703 can obtain a finer PMI than with a single codebook, alone.

In one aspect of the present disclosure, multiple description coding (MDC)-type results may be achieved by precoding CSI-RS transmissions with varying parameters, using only one codebook. Thus, multiple values are obtained without changing code books. In particular, consecutive differing CSI-RSs may be obtained and analyzed to decrease quantization error. In this aspect a varying parameter (such as beam, frequency or antenna port) is applied to consecutive CSI-RS transmissions to obtain the differing CSI-RS values. This aspect may be achieved invisibly to the UE or with minimal UE impact, as the UE is not required to cycle through multiple codebooks. Instead, the eNodeB varies the properties for the CSI-RS transmission in a known pattern and leverages that known pattern in conjunction with the resulting received different CSI reports to generate a refined CSI report (e.g., PMI) or associated CSI values.

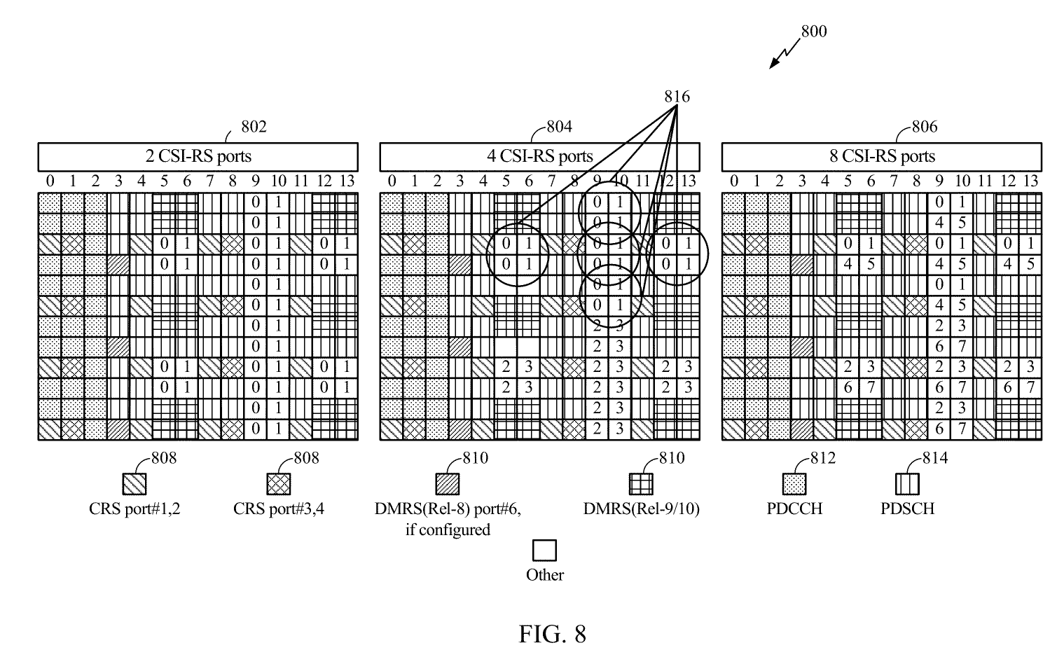

FIG. 8 is a diagram 800 illustrating reference signal configurations in various resource blocks. In operation, each CSI-RS port may be assigned to a different UE and/or multiple CSI-RS ports may be assigned to a single UE. FIG. 8 shows a configuration for two CSI-RS ports 802, a configuration for four CSI-RS ports 804, and a configuration for eight CSI-RS ports 806. The location of various reference signals are depicted using various shaded blocks. For example, the CRS ports 1, 2, 3 and 4 are depicted with reference to element 808; the DM-RS (LTE release 8) and DM-RS (LTE release 9 and 10) ports are depicted with reference element 810; PDCCH is depicted with reference to element 812; and PDSCH is depicted with reference to element 814. Further, CSI-RS groupings in the four CSI port configuration 804 are depicted with reference to element 816.

In one configuration, the UEs are served using transmission mode 9 (TM9) where the channel state information reference signal (CSI-RS) may be used for channel estimation. The UE estimates the channel, for the sake of PMI reporting in TM9, using the latest CSI-RS opportunity (e.g., a single subframe). To prevent the UE from averaging multiple CSI-RS transmissions, averaging restrictions may be applied by providing subframe subsets to the UE. For example, in one configuration, the UE uses one single subframe for each CSI-RS for channel estimation, to prevent averaging at the UE side.

The CSI-RS can be beam formed by the eNodeB. On each consecutive CSI-RS transmission, the serving eNodeB can apply a different beam. As a result of the beam forming, the eNodeB receives differing CSI-RS reports from the UE. Since the eNodeB is aware of the variances introduced by the different beams, the eNodeB can then perform analysis at the base station by correlating the different beams and corresponding CSI reports to reduce quantization error, and obtain improved CSI values having finer quantization ranges. Since the eNodeB can correlate the different beams with their resulting CSI reports, while the UE may employ only a single codebook, the UE does not need to be aware of the beams employed by the eNodeB or the process employed by the eNodeB to reduce quantization error in the CSI reports.

The eNodeB applies a different beam for each CSI-RS transmission. The beams may be selected according to the same strategy used for MDC. If the CSI is slowly varying, and the beam pattern is suitably selected, the eNodeB can reconstruct PMI with a much better accuracy by combining multiple consecutive reports. For example, the eNodeB may combine multiple consecutive reports, knowing the beams it selected for each CSI transmission to improve the estimation of the spatial channel or channel direction.

In one configuration, the number of reports that can be combined is dependent on the amount of channel correlation among the various reports, which may depend on the Doppler rate (e.g., the UE speed) and reporting periodicity. For example, if the UE is moving very fast, the eNodeB may decide to combine very few reports, or may instead use only the most recent report instead of combining reports.

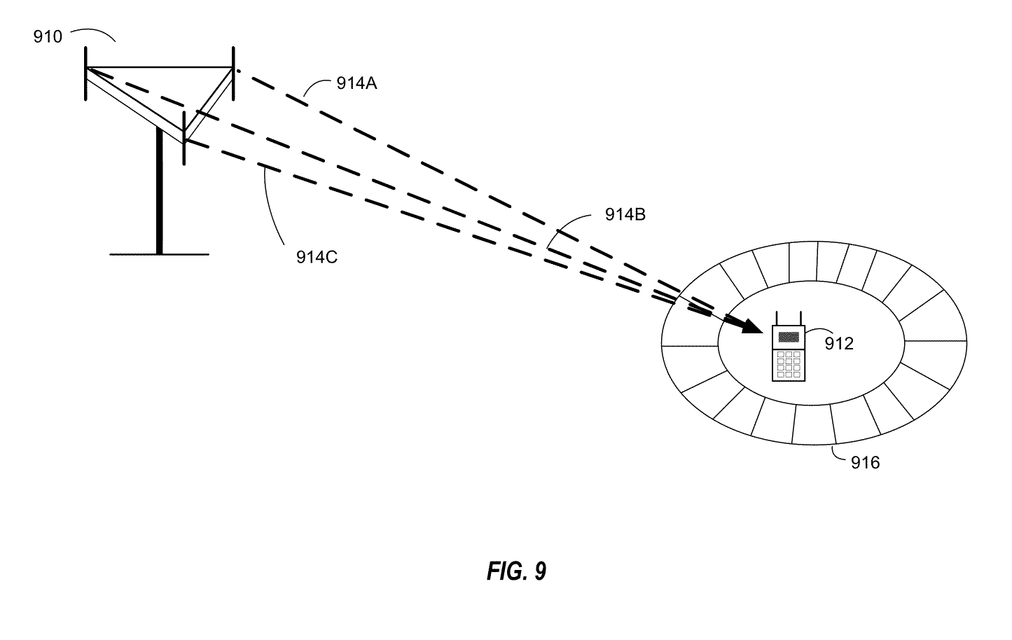

FIG. 9 illustrates a simplified two dimensional example of the beam forming application. An eNodeB 910 applies beams 914A, 914B and 914C for different CSI-RS transmissions sent from the eNodeB 910 to the UE 912. The eNodeB 910 changes the origin of the CSI-RS transmissions by varying the beams used for the CSI-RS transmissions. Accordingly, each of the beams 914A-914C approach the UE from different directions.

In this aspect the UE 912 may utilize a single codebook 916 (though alternative implementations may utilize multiple codebooks in accordance and combination with the prior aspect). When the eNodeB 910 transmits CSI-RS, the UE 912 reports a particular precoding matrix indicator (PMI) from the codebook 916. Because the eNodeB transmits CSI-RS on beams of varying origins, the UE 912 reports different PMI values for the CSI-RS. The reports are generated based on the different beams (914A, 914B and 914C). The eNodeB 910 can combine the reports based on the known beam directions and origins to improve the estimation of the spatial channel or channel direction based on the different resulting PMIs.

In one aspect, the mathematical model below illustrates an example of the beam forming application by the eNodeB:

y=V^{H} HU x+z,

PMI=arg max F(HUC_{q}, R_{zz})

where V represents the Hermitian of the receiver matrix at the UE side, H is the channel being estimated, x is the transmit vector, y is the receive vector and z represents noise (e.g., interference). Additionally, U represents the beam forming matrix applied by the eNodeB on the CSI-RS tones.

C_{q} is the qth entry of the codebook and the codebook has Q entries. F is the utility function that depends on the composite channel (e.g., combination of channel, precoder, and codebook) and the interference covariance matrix R_{zz}. For example, F( ) may entail computing an optimal receiver matrix according to the minimum mean square error (MMSE) criterion and evaluating an achievable signal-to-noise ratio or channel capacity under the current composite channel conditions (along with interference).

The beam forming matrix, U, changes in each subframe, resource block and/or antenna port where CSI-RS is transmitted. In one example, varying the beam forming matrix for each CSI-RS transmission may be similar to using a new codebook for each subframe.

The process may be applied to other domains beside the time domain. For example, the frequency domain may be used. Beam forming changes in the frequency domain may be applied in different resource blocks. That is, each resource block has a different CSI-RS.

In alternate configurations, other domains may be used. In one example, the antenna domain is used. For example, the eNodeB may declare more CSI-RS antenna ports than there are physical antennas, so there are more logical antennas than physical antennas. Using the mathematical models discussed above, the values for H, U and Cq values may be described as follows: H is the size of N_{RX}×N_{TX}^{PHY}, where N_{RX} corresponds to the number of receiver antenna, and N_{TX}^{PHY} corresponds to the physical antennas. Additionally, the size of U is represented by N_{NT}^{PHY}×N_{TX}^{CSI-RS}, where N_{TX}^{CSI-RS} corresponds to the declared antenna ports. Further, C_{q} corresponds to the entries of a codebook which assumes N_{TX}^{CSI-RS} antenna ports.

In one example, it is assumed two physical antennas exist, but four antenna ports are defined for CSI-RS transmission. In this example the matrix U may be defined as U(t)=[U1(t), U2(t)] where U1(t) and U2(t) have size 2×2. The UE believes there are four antennas and thus uses the corresponding codebook. The base station projects the reported four antenna PMI to the corresponding two antenna PMI based on the knowledge of U1(t) and U2(t).

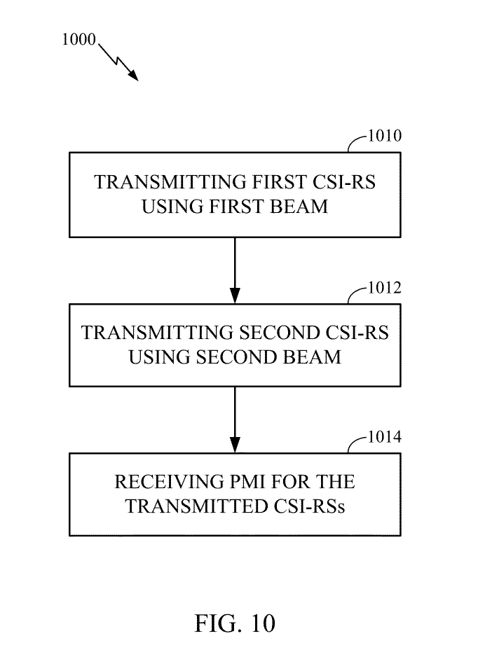

One aspect of the present disclosure is directed to improving CSI reporting by reducing the quantization error due to codebook-based PMI reporting. In particular, multiple description coding (MDC)-type results are achieved by precoding CSI-RS transmissions with varying parameters without changing codebooks. Rather only one codebook is used. Based on the known codebook and corresponding PMI, the eNodeB can obtain a finer PMI. FIG. 10 illustrates an example method 1000 for improving PMI reporting via the CSI-RS.

Consecutive differing CSI-RS values are obtained and analyzed to decrease quantization error. A varying parameter, such as a beam, is applied to consecutive CSI-RS transmissions to obtain different CSI-RS values. In particular, an eNodeB varies the properties of the CSI-RS transmission by transmitting the CSI-RS on different beams. For example, in block 1010, an eNodeB transmits a first channel state information reference signal (CSI-RS) on a first beam.

On each consecutive CSI-RS transmission, the serving eNodeB applies a different beam. For example, in block 1012, the eNodeB transmits a second CSI-RS on a second beam different from the first beam.

When the eNodeB transmits CSI-RS, the UE will report a particular PMI from a codebook. Because the eNodeB is transmitting CSI-RS on varying beams, the UE 912 reports different PMI values for the CSI-RS. For example, in block, 1014, the eNodeB receives precoding matrix indicators (PMIs) from a UE for each of the transmitted CSI-RSs. The eNodeB can combine the reports, and then with the known beam direction information and known codebook, improve the estimation of channel direction based on the resulting PMIs.

In one configuration, the eNodeB 610 is configured for wireless communication including means for transmitting a first channel state information reference signal. In one aspect, the transmitting means may be the controller/processor 675, memory 676, transmit (TX) processor 616, transmitters 618; and/or antenna 620, configured to perform the functions recited by the transmitting means. The eNodeB 610 is also configured to include a means for transmitting a second CSI-RS. In one aspect, the second transmitting means may be the controller/processor 675, memory 676, transmit (TX) processor 616, transmitters 618; and/or antenna 620 configured to perform the functions recited by the second transmitting means. The eNodeB 610 is also configured to include a means for receiving PMI for each of the transmitted beams. In one aspect, the receiving means may be the antenna 620, receivers (RX) 618, receiver (RX) processor 670, the controller/processor 675 and/or the memory 676 configured to perform the functions recited by the receiving means. In another aspect, the aforementioned means may be any module or any apparatus configured to perform the functions recited by the aforementioned means.

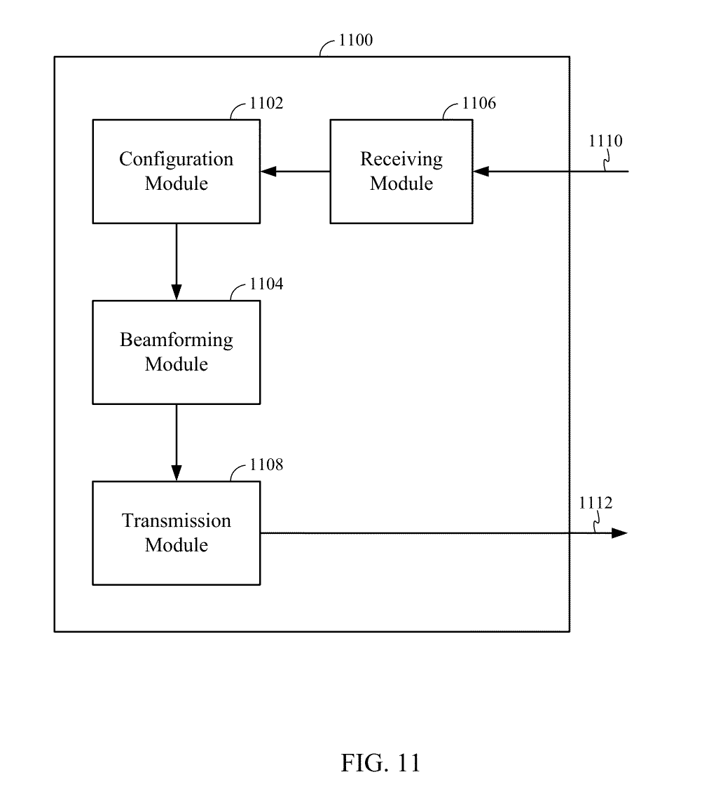

FIG. 11 is a conceptual data flow diagram illustrating the data flow between different modules/means/components in an exemplary apparatus 1100.

The apparatus 1100 includes a beamforming module 1104 that determines vectors for the beams transmitting CSI-RS, in which the beams have varying vector components. The beamforming module 1104 sends the vector components for the beams to the transmission module 1108. Transmission module 1108 then transmits the various beams 1112 carrying CSI-RS. A receiving module 1106 receives PMI reports 1110 from a UE and sends the received reports to a configuration module 1102 that can reconstruct PMI with improved accuracy by combining multiple consecutive reports. The configuration module 1102 passes this information to the beamforming module 1004.

The apparatus may include additional modules that perform each of the steps of the process in the aforementioned flow charts FIG. 10. As such, each step in the aforementioned flow charts FIG. 10 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

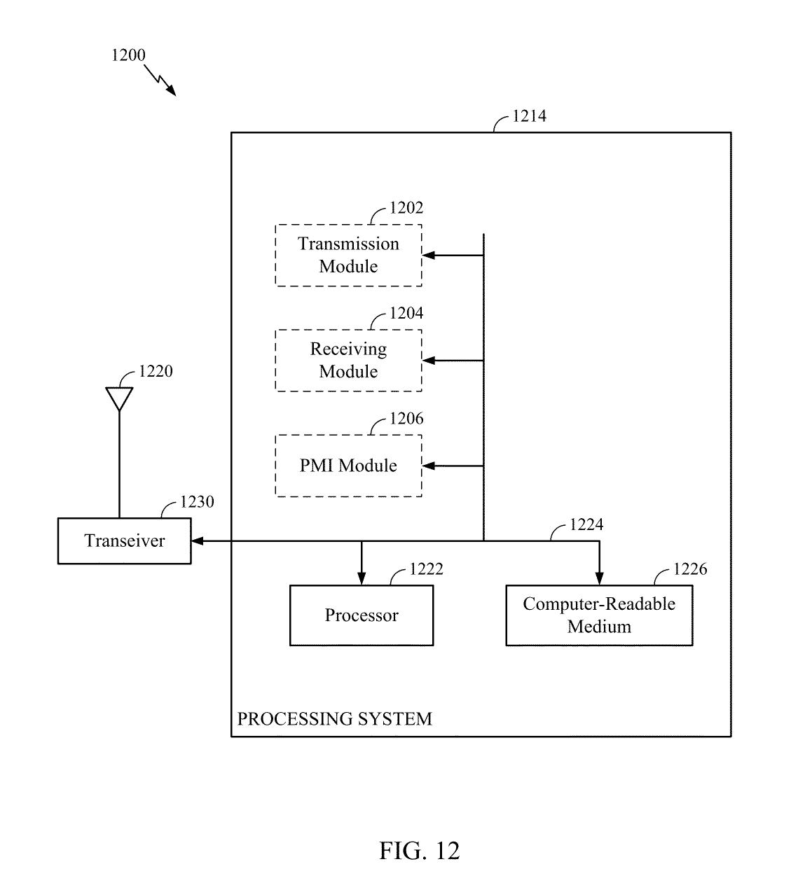

FIG. 12 is a diagram illustrating an example of a hardware implementation for an apparatus 1200 employing a processing system 1214. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware modules, represented by the processor 1222 the modules 1202, 1204, 1206 and the computer-readable medium 1226. The bus 1224 may also link various other circuits such as timing sources, peripherals, voltage regulators, and power management circuits, which are well known in the art, and therefore, will not be described any further.

The apparatus includes a processing system 1214 coupled to a transceiver 1230. The transceiver 1230 is coupled to one or more antennas 1220. The transceiver 1230 enables communicating with various other apparatus over a transmission medium. The processing system 1214 includes a processor 1222 coupled to a computer-readable medium 1226. The processor 1222 is responsible for general processing, including the execution of software stored on the computer-readable medium 1226. The software, when executed by the processor 1222, causes the processing system 1214 to perform the various functions described for any particular apparatus. The computer-readable medium 1226 may also be used for storing data that is manipulated by the processor 1222 when executing software.

The processing system 1214 includes a transmission module 1202, a receiving module 1204, and a PMI module 1206. The transmitting module 1202 can transmit CSI-RS on various different beams. The receiving module 1204 can receive PMI reports from a UE. The PMI module 1206 can combine various received PMI reports to reconstruct a more accurate PMI. The modules may be software modules running in the processor 1222, resident/stored in the computer readable medium 1226, one or more hardware modules coupled to the processor 1222, or some combination thereof. The processing system 1214 may be a component of the eNodeB 610 and may include the memory 676, the transmit processor 616, the receive processor 670, the transmitters/receivers 618, the antenna 620, and/or the controller/processor 675.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
transmitting a first channel state information reference signal (CSI-RS) to at least one UE using a first beam;
transmitting a second CSI-RS to at least one UE using a second beam, which differs from the first beam; and
receiving precoding matrix indicators (PMIs) from at least one UE for the transmitted CSI-RSs.

2. The method of claim 1, further comprising generating a refined PMI for the at least one UE based on variances in the received PMIs and variances between the first transmitted CSI-RS and the second transmitted CSI-RS.

3. The method of claim 1, in which the received PMIs are associated with a coarser quantization granularity than the refined PMI.

4. The method of claim 1, in which the receiving comprises receiving a first precoding matrix indicator (PMI) for the first transmitted CSI-RS and receiving a second PMI for the second transmitted CSI-RS; and further comprising combining the received PMIs to construct a channel estimate.

5. The method of claim 1, in which the first CSI-RS is transmitted at a first time, and the second CSI-RS is transmitted at a second consecutive time.

6. The method of claim 1, in which the first CSI-RS is transmitted in a first frequency, and the second CSI-RS is transmitted in a second frequency.

7. The method of claim 1, in which the first CSI-RS is transmitted from a first set of CSI-RS antenna ports, and the second CSI-RS is transmitted from a second set of CSI-RS antenna ports.

8. The method of claim 1, further comprising transmitting at least one additional CSI-RS, in which each additionally transmitted CSI-RS is transmitted on a different beam.

9. The method of claim 8, further comprising:
receiving a precoding matrix indicator (PMI) for each transmitted CSI-RS;
determining a number of PMIs to combine; and
combining the determined number of PMIs.

10. The method of claim 9, in which determining the number of PMIs to combine is based on an estimated rate of channel variation.

11. An apparatus for wireless communication, comprising:
means for transmitting a first channel state information reference signal (CSI-RS) to at least one UE using a first beam;
means for transmitting a second CSI-RS to at least one UE using a second beam, which differs from the first beam; and
means for receiving precoding matrix indicators (PMIs) from at least one UE for the transmitted CSI-RSs.

12. A computer program product for wireless communication in a wireless network, comprising:
a non-transitory computer-readable medium having non-transitory program code recorded thereon, the program code comprising:
program code to transmit a first channel state information reference signal (CSI-RS) to at least one UE using a first beam;
program code to transmit a second CSI-RS to at least one UE using a second beam, which differs from the first beam; and
program code to receive precoding matrix indicators (PMIs) from at least one UE for the transmitted CSI-RSs.

13. An apparatus for wireless communication, comprising:
a memory; and
at least one processor coupled to the memory, the at least one processor being configured:
to transmit a first channel state information reference signal (CSI-RS) to at least one UE using a first beam;
to transmit a second CSI-RS to at least one UE using a second beam, which differs from the first beam; and
to receive precoding matrix indicators (PMIs) from at least one UE for the transmitted CSI-RSs.

14. The apparatus of claim 13, in which the at least one processor is further configured to generate a refined PMI for the at least one UE based on variances in the received PMIs and variances between the first transmitted CSI-RS and the second transmitted CSI-RS.

15. The apparatus of claim 13, in which the received PMIs are associated with a coarser quantization granularity than the refined PMI.

16. The apparatus of claim 13, in which the at least one processor is configured to receive by receiving a first precoding matrix indicator (PMI) for the first transmitted CSI-RS and by receiving a second PMI for the second transmitted CSI-RS; and in which the at least one processor is further configured to combine the received PMIs to construct a channel estimate.

17. The apparatus of claim 13, in which the first CSI-RS is transmitted at a first time, and the second CSI-RS is transmitted at a second consecutive time.

18. The apparatus of claim 13, in which the first CSI-RS is transmitted in a first frequency, and the second CSI-RS is transmitted in a second frequency.

19. The apparatus of claim 13, in which the first CSI-RS is transmitted from a first set of CSI-RS antenna ports, and the second CSI-RS is transmitted from a second set of CSI-RS antenna ports.

20. The apparatus of claim 13, further comprising transmitting at least one additional CSI-RS, in which each additionally transmitted CSI-RS is transmitted on a different beam.

21. The apparatus of claim 20, in which the at least one processor is further configured:
to receive a precoding matrix indicator (PMI) for each transmitted CSI-RS;
to determine a number of PMIs to combine; and
to combine the determined number of PMIs.

22. The apparatus of claim 21, in which the at least one processor is configured to determine the number of PMIs to combines based on an estimated rate of channel variation.
